(19) United States
(12) Patent Application Publication
(10) Pub. No.: US 2014/0149348 A1
(43) Pub. Date: May 29, 2014

(54) APPLICATION PROGRAM MANAGEMENT METHOD AND APPARATUS USING CONTEXT INFORMATION

(71) Applicant: Electronics and Telecommunications Research Institute, Daejeon (KR)

(72) Inventors: Eun-Jeong CHOI, Daejeon (KR); Hye-Won SONG, Daejeon (KR); Chang-Seok BAE, Daejeon (KR); Jeun-Woo LEE, Daejeon (KR)

(73) Assignee: Electronics and Telecommunications Research Institute, Daejeon (KR)

(21) Appl. No.: 14/011,653

(22) Filed: Aug. 27, 2013

(30) Foreign Application Priority Data
Nov. 28, 2012 (KR) 10-2012-0136398

(51) Int. Cl. G06F 17/30

(52) U.S. Cl. CPC G06F 17/30581
USPC 707/624

(57) ABSTRACT

An application program management method and apparatus using information are provided. The application program management method includes: in response to the state of an application program being changed in a first terminal, notifying a second terminal of the occurrence of an application program update in the first terminal; and in response to the second terminal recognizing the occurrence of an application program update in the first terminal, providing the second terminal with the state-changed application program or updated information relating to the state-changed application program.

### CROSS-REFERENCE TO RELATED APPLICATION(S)

This application claims the benefit under 35 U.S.C. §119(a) of Korean Patent Application No. 10-2012-0136398, filed on Nov. 28, 2012, in the Korean Intellectual Property Office, the entire disclosure of which is incorporated herein by reference for all purposes.

### BACKGROUND

1. Field

The following description relates to a technique for the management and synchronization of application programs.

2. Description of the Related Art

In a cloud computing environment, a user can access the same content via different terminals by means of a synchronization service for personal information and content such as files, emails, etc.

One of the most popular cloud services is Apple's iCloud. Current cloud services support an effective management of content in a plurality of terminals of a user, such as personal information (for example, contact information and schedule information), photos, multimedia data and documents, through synchronization, but are generally limited in that they merely support the synchronization of application programs only between terminals using a homogeneous platform. Apple's application program synchronization process, in particular, is characterized as a one-on-one synchronization between terminals via iTunes, rather than via a cloud server, and allows only email data, contact information, schedule information (“Calendar”), and documents to be synchronized via a cloud server.

Apple's application program synchronization process is carried out via iTunes in response to iOS equipment being connected to one or more authorized computers. In this case, if the authorized computers have different lists of application programs, the iOS equipment only synchronizes application programs between the authorized computers, and Apple's iCloud merely backs up application programs without synchronizing them. iCloud's real time synchronization feature is only limited to emails, contact information, schedule information (“Calendar”), iWork, etc.

### SUMMARY

The following description relates to an application program management method and apparatus using context information, in which application programs can be synchronized not only between homogeneous platform-based terminals but also between heterogeneous platform-based terminals.

In one general aspect, an application program management method includes: in response to the state of an application program being changed in a first terminal, notifying a second terminal of the occurrence of an application program update in the first terminal; and in response to the second terminal recognizing the occurrence of an application program update in the first terminal, providing the second terminal with the state-changed application program or updated information relating to the state-changed application program.

The first and second terminals may both be authorized by the same user and may run on a homogeneous platform or heterogeneous platforms.

The notifying may include: receiving an update request message for the state-changed application program and information relating to the state-changed application program from the first terminal; and in response to the receipt of the update request message, updating existing information relating to the state-changed application program and transmitting a push alarm message indicating the occurrence of an application program update in the first terminal to the second terminal via a push server.

The providing may include: receiving a request for the information relating to the state-changed application program from the second terminal; and transmitting the updated information relating to the state-changed application program or information relating to a recommended application program associated with the state-changed application program to the second terminal based on context information of the second terminal.

The context information may include terminal information, user information, application program information and application program execution information, wherein the terminal information includes terminal specification information and real-time information that varies in real time and includes terminal location information and the frequency of the use of each application program, the user information includes a user's application program use history and the application program information includes application program installation information and application program execution state information. The updated information relating to the state-changed application program may include link information of an application program store from which the second terminal can obtain the state-changed application program, content to be generated in response to the execution of the state-changed application program and execution state information of the state-changed application program.

The providing may include: in response to the receipt of a request for information relating to the state-changed application program from the second terminal, determining whether the first and second terminals are of heterogeneous types based on context information of the second terminal; in response to a determination being made that the first and second terminals are of heterogeneous types, determining whether the state-changed application program exists in an application program store of the second terminal, transmitting link information for obtaining the state-changed application program to the second terminal in response to the state-changed application program existing in the application program store of the second terminal, and transmitting information relating to a recommended application program associated with the state-changed application program to the second terminal in response to the state-changed application program not existing in the application program store of the second terminal; and in response to a determination being made that the first and second terminals are of a homogeneous type, transmitting link information of an application program store from which the second terminal can obtain the state-changed application program to the second terminal.

In another general aspect, an application program management method includes: receiving application program-related information and context information from a plurality of terminals of a user and analyzing the user's pattern of use of application programs installed in each of the terminals, the plurality of terminals comprising first and second terminals; modeling the user's pattern of use of the application programs based on the results of the analyzing; and synchronizing the application programs between the terminals based on the modeled pattern of use of the application programs.

The synchronizing may include recommending information relating to an application program with a predetermined frequency of use in the first terminal to the second terminal based on the modeled pattern of use of the application programs.

The synchronizing may include controlling and managing a period of synchronization of the application programs and a list of application programs to be synchronized between the terminals.

The analyzing may include: calculating hitting rates of the application programs for each time period based on an application program use history included in the context information; and calculating use state values of the application programs for each of the terminals based on the calculated hitting rates. The modeling may include modeling the user's pattern of use of the application programs for each of the terminals based on the calculated use state values and storing the modeled pattern of use of the application programs.

The synchronizing may include: comparing the calculated use state values with their respective historic values; in response to the calculated use state values being greater than their respective historic values, adjusting synchronization priority levels of the application programs and the period of synchronization of the application programs based on the calculated use state values; and in response to the calculated use state values being less than their respective historic values, comparing the calculated use state values with a threshold value, adjusting the synchronization priority levels of the application programs and the period of synchronization of the application programs based on the calculated use state values in response to the calculated use state values being greater than the threshold value, and terminating synchronization of the application programs in response to the calculated use state values being less than the threshold value.

In another general aspect, an application program management apparatus includes: a context modeling unit configured to collect context information from a plurality of terminals of a user and model the context information into a form suitable for use in connection with application programs; an application program providing unit configured to provide an application program whose state is changed in a first terminal or updated information relating to the state-changed application program to a second terminal based on the modeled context information; and an application program synchronization unit configured to in response to the detection of the state-changed application program, update existing information relating to the state-changed application program and notify the second terminal of the occurrence of an application program update in the first terminal.

Other features and aspects may be apparent from the following detailed description, the drawings, and the claims.

According to embodiments, it is possible to provide the same user experience (UX) to a user in connection with the use of an application program via multiple terminals using a homogeneous platform or heterogeneous platforms. That is, even if the state of an application program is changed in one of the multiple terminals (for example, the application program is added to, deleted from, or updated in the terminal), the user can easily use the application program in the other terminals regardless of whether the multiple terminals are of a homogeneous type or heterogeneous types.

According to embodiments, in response to the state of an application program being changed in one of a plurality of terminals of a user, the application program and an environment in which to execute the application program are also synchronized in real time to the rest of the terminals. As a result, the user can use the plurality of terminals in the same environment. In addition, even in a personal cloud computing environment, application programs can be synchronized between a single personal cloud server and multiple terminals, i.e., a 1:N application program synchronization can be provided.

### BRIEF DESCRIPTION OF THE DRAWINGS

FIG. 1 is a diagram illustrating an example of an application program management system.

FIG. 2 is a diagram illustrating an example of a network to which the present inventive concept is applied.

FIG. 3 is a diagram illustrating another example of the network to which the present inventive concept is applied.

FIG. 4 is a block diagram illustrating examples of an application program management apparatus and a terminal;

FIG. 5 is a diagram illustrating an example of the transmission of data between the application program management apparatus and terminals for synchronizing application programs between the terminals.

FIG. 6 is a flowchart illustrating an example of the transmission of data between the application program management apparatus and the terminals for synchronizing application programs between the terminals.

FIG. 7 is a detailed flowchart illustrating the example of FIG. 6.

FIG. 8 is a diagram illustrating an example of the transmission of data between the application program management apparatus and terminals for providing intelligent application program-related information based on an application program use history.

FIG. 9 is a diagram illustrating an example of the transmission of data between the application program management apparatus and terminals for providing intelligent application program-related information based on location information.

FIG. 10 is a flowchart illustrating an example of the provision of an application program based on context information.

FIG. 11 is a flowchart illustrating an example of the synchronization of application programs between terminals based on context information.

FIG. 12 is a detailed flowchart illustrating an example of the modeling of the pattern of use of application programs through analysis, as performed in the process of synchronization illustrated in FIG. 11.

FIG. 13 is a detailed flowchart illustrating an example of the control of the frequency of the synchronization of application programs and the control of application programs to be synchronized based on the state of use of each application program, as performed in the process of synchronization illustrated in FIG. 11.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

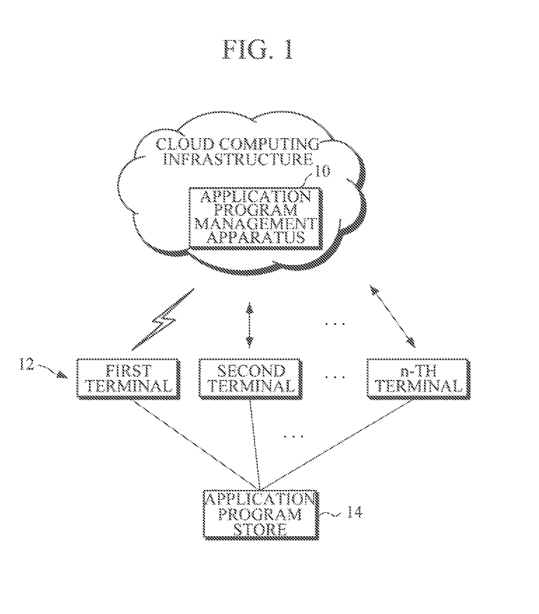

FIG. 1 is a diagram illustrating an example of an application program management system.

Referring to FIG. 1, the application program management system includes an application program management apparatus 10, one or more terminals 12 and an application program store 14.

The terminals 12 may include nearly all types of electronic devices in which to install and execute application programs. In an example, the terminals 12 may include, but are not limited to, various devices such as a smartphone, a smart tab, a notebook computer, an electronic book (e-book) reader, an Internet Protocol TV (IPTV) set, a portable multimedia player (PMP), a navigation device, an MP3 player, a mobile broadcast receiver, a digital camera, a computer, etc. The application program management system may include a plurality of terminals 12 held by the same user. The application program management system may include as the terminals 12 devices that run on a homogeneous platform and may also include devices that run on heterogeneous platforms. In an example, the terminals 12 may include smart pads that run on Android and i-phones that run on iOS.

The application program management apparatus 10 provides application programs or information relating to the application programs to the terminals 12. The application program management apparatus 10 may be a server, and particularly, a cloud server. A cloud server-type application program management apparatus 10 may provide personal cloud computing (PCC) services to the terminals 12. That is, the application program management apparatus 10 may provide via the Internet application programs or application program-related information requested by the terminals 12. The internet is often illustrated as a cloud because of its complicated, hidden infrastructure. A user may be provided with a desired application program at any time through the internet due to PCC infrastructure. The application program store 14 is a place where the user can purchase one or more application programs to be installed in the terminals 12. In an example, the application program store 14 may be Apple's App Store or Google's Android Market.

The present inventive concept aims at providing the same user experience (UX) regardless of the type of terminal used. That is, in response to the state of an application program being changed in one of the terminals 12 due to the addition, deletion or update of the application program, the state of the application program may also be changed in the rest of the terminals 12. The state of an application program may be updated in real time. For this, the application program management apparatus 10 synchronizes application programs between the terminals 12. In an example, in response to the user installing an application program in one of the terminals 12, information relating to the application program is transmitted to the application program management apparatus 10 on a “cloud”, and the application program management apparatus 10 may control the application program to be also installed in the rest of the terminals 12. As a result, the same application program may be installed in all the terminals 12 held by the user.

The synchronization of application programs by the application program management apparatus 10 may be performed in two different manners. First, the application program management apparatus 10 may provide an application program directly to the terminals 12. Second, in response to the application program management apparatus 10 providing information relating to an updated application program to the terminals 12, the terminals 12 may obtain the updated application program from the application program store 14 and may install the obtained application program therein. The term “update”, as used herein, may indicate nearly all types of changes that can be made to the state of an application program due to the addition, deletion and update of the application program.

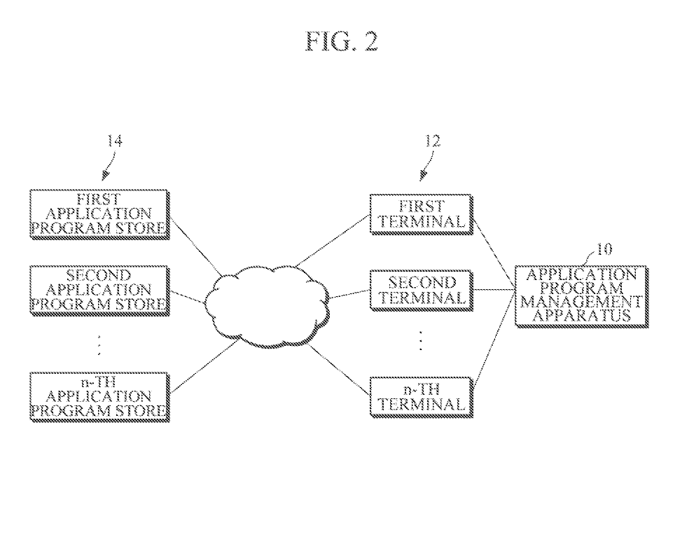

FIG. 2 is a diagram illustrating an example of a network to which the present inventive concept is applied.

Referring to FIG. 2, a user may possess a plurality of terminals 12 that are based on a homogeneous platform or heterogeneous platforms, and one or more application program management apparatuses 10 may be provided. The terminals 12 may be provided with application programs by their respective application program stores 14 and may install the application programs.

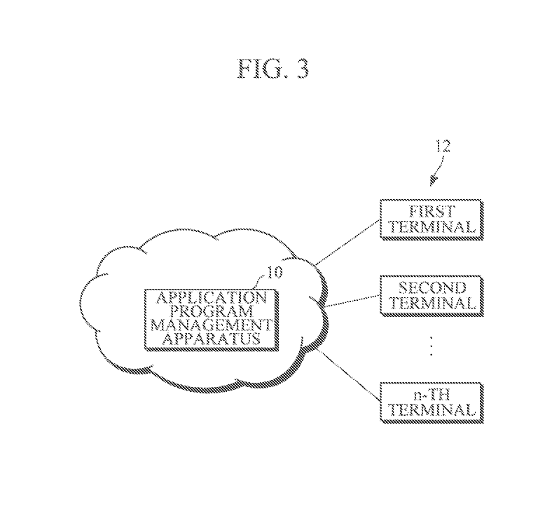

FIG. 3 is a diagram illustrating another example of the network to which the present inventive concept is applied.

Referring to FIG. 3, a user may possess a plurality of terminals 12 that are based on a homogeneous platform or heterogeneous platforms, and one or more application program management apparatuses 10 may be provided. Each of the application program management apparatuses 10, which are on a “cloud”, may synchronize application programs between the terminals 12. It may vary from one terminal 12 to another terminal 12 where the terminals 12 can obtain application programs depending on the policy of the application program stores 14.

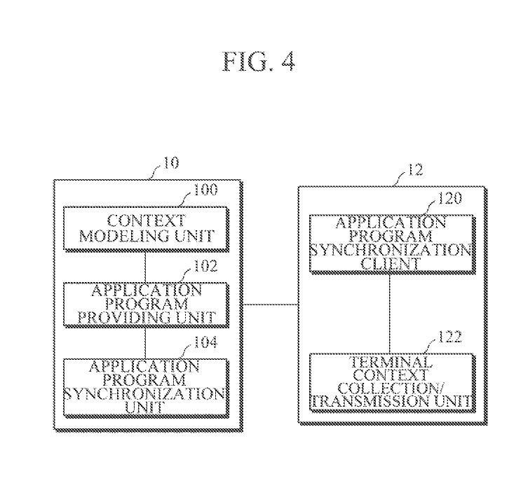

FIG. 4 is a block diagram illustrating examples of an application program management apparatus 10 and a terminal 12.

Referring to FIG. 4, the application program management apparatus 10 manages context information, which includes terminal information and user information and may vary in real time, collects and stores the content information, and models the context information, thereby providing application program-related information to the terminal 12. In an example, the application program management apparatus 10 may synchronize the environment of execution of application programs between terminals so that the same UX can be provided regardless of which of the terminals is being used. In this example, in response to an application program being updated in one of a plurality of terminals held by a user, the application program may also be updated in the rest of the plurality of terminals so that the user can use the application program in the same environment with the use of any one of the plurality of terminals.

The application program management apparatus 10 includes a context modeling unit 100, an application program providing unit 102 and an application program synchronization unit 104.

The context modeling unit 100 collects context information from one or more terminals possessed by a user and models the context information into a form suitable for use in connection with application programs. The context information includes terminal information, user information and application program information and application program execution information for each terminal. The terminal information includes terminal specification information and information that may vary in real time such as terminal location information and the frequency of the use of each application program. The user information may include the user's application program use history, i.e., information generated in response to the use of each application program such as the number, duration and amount of use of each application program. The user information may also include content use information generated in response to the use of each application program. The context information may include real-time information that may vary in real time in response to the use of each by the user.

The context modeling unit 100 may calculate the hitting rate of an application program installed in each terminal for each time period based on the user's application program use history, included in the context information, may calculate the use state value of the application program for each terminal based on the calculated hitting rate(s), may model the pattern of the use of the application program based on the calculated use state value(s), and may store the modeled pattern.

The application program providing unit 102 provides an application program whose state is changed in a first terminal or updated information relating to the state-changed application program to a second terminal based on the context information modeled by the context modeling unit 100. The updated information relating to the state-changed application program may include link information to an application program store where the state-changed application program can be obtained.

In an example, in response to the receipt of a request for the transmission of information relating to a predetermined application program from the second terminal, the application program providing unit 102 transmits the information relating to the predetermined application program or information relating to a recommended application program associated with the predetermined application program to the second terminal.

More specifically, in response to the receipt of a request for the transmission of information relating to the predetermined application program from the second terminal, the application program providing unit 102 determines whether the first and second terminals are of heterogeneous types based on context information of the second terminal. In a case in which the first and second terminals are of heterogeneous types, the application program providing unit 102 determines whether the predetermined application program exists in an application program store, and transmits link information for obtaining the predetermined application program to the second terminal if the predetermined application program exists in the application program store. On the other hand, in a case in which the predetermined application program does not exist in the application program store, the application program providing unit 102 transmits information relating to a recommended application program associated with the predetermined application program to the second terminal. In a case in which the first and second terminals are of a homogeneous type, the application program providing unit 102 transmits link information for obtaining the predetermined application program to the second terminal.

In response to the update of an application program in the first terminal, the application program synchronization unit 104 updates information relating to the application program and notifies the second terminal of the update of the application program.

In an example, the application program synchronization unit 104 may receive from the first terminal an update request message for an application program updated or newly installed in the first terminal and information relating to the updated or newly installed application program, updates existing information relating to the updated or newly installed application program, and transmits a push alarm message indicating the occurrence of an update in the first terminal to the second terminal via a push server.

The terminal 12 includes an application program synchronization client 120 and a terminal context collection/transmission unit 122.

The application program synchronization client 120 notifies the application program management apparatus 10 of the update of an application program. In response to the receipt of application program-related information for application program synchronization from the application program management apparatus 10, the application program synchronization client 120 may obtain an application program corresponding to the received application program-related information from an application program store and may install the obtained application program in the terminal 12. The terminal context collection/transmission unit 122 collects context information of the terminal 12 and transmits the collected context information to the application program management apparatus 10.

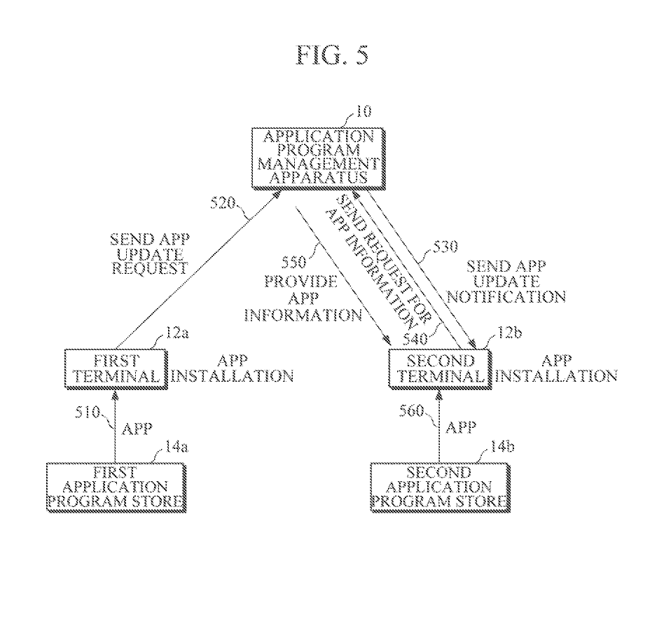

FIG. 5 is a diagram illustrating an example of the transmission of data between an application program management apparatus and terminals for synchronizing application programs between the terminals.

Referring to FIG. 5, in response to a user obtains a predetermined application program from a first application program store 14 and installing the obtained application program in a first terminal 12a of the user in 510, the first terminal 12a discovers and collects information relating to the predetermined application program and transmits in 520 an update event to an application program management apparatus 10. In response to the receipt of the update event from the first terminal 12a, the application program management apparatus 10 notifies in 530 a second terminal 12b of the user of the occurrence of an update in the first terminal 12a. The second terminal 12b recognizes the occurrence of an update in the first terminal 12a, sends in 540 a request for information relating to an updated application program to the application program management apparatus 10, and receives the requested information in 550. The second terminal 12b obtains an application program corresponding to the received information from a second application program store 14 and installs the obtained application program in 560.

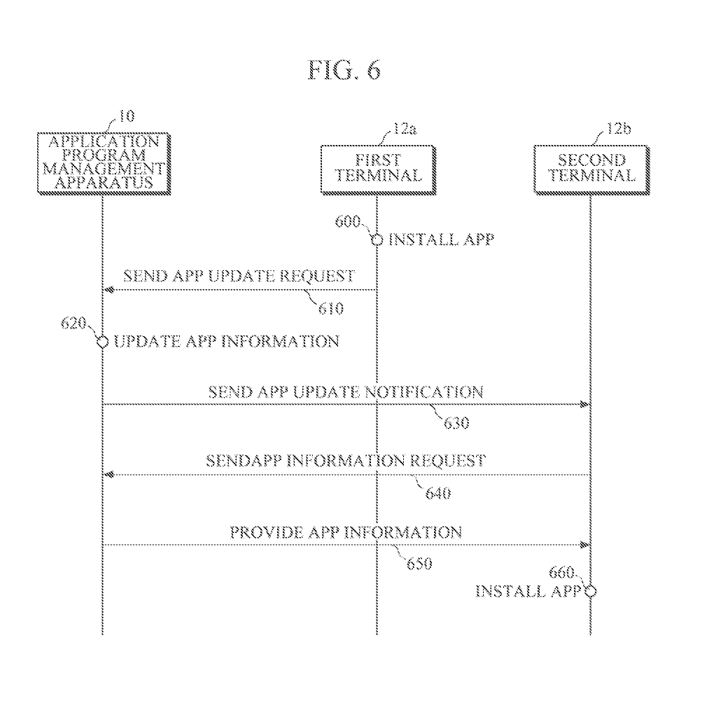

FIG. 6 is a flowchart illustrating an example of the transmission of data between the application program management apparatus and the terminals for synchronizing application programs between the terminals.

Referring to FIG. 6, a user purchases an application program from an application program store by means of a first terminal 12a of the user and installs the purchased application program in 600. The first terminal 12a discovers and collects information relating to the predetermined application program and sends an update request to an application program management apparatus 10 together with the collected information in 610.

In response to the receipt of the update request, the application program management apparatus 10 updates existing information relating to the predetermined application program in 620, and notifies a second terminal 12b of the user of the update of the information relating to the predetermined application program in 630. The second terminal 12b recognizes the update of the information relating to the predetermined application program and sends a request for the transmission of the updated information relating to the predetermined application program to the application program management apparatus 10 in 640. The application program management apparatus 10 provides the updated information relating to the predetermined application program to the second terminal 12b in 650. The updated information relating to the predetermined application program may include link information for obtaining the predetermined application program from an application program store.

The second terminal 12b obtains the predetermined application program from an application program store based on the updated information provided by the application program management apparatus 10, and installs the obtained application program in 660.

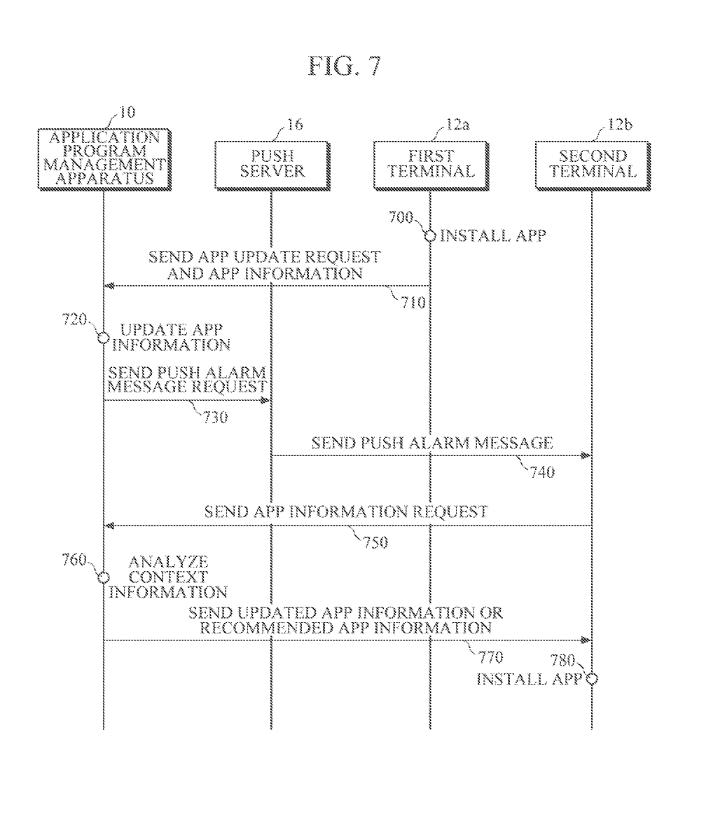

FIG. 7 is a detailed flowchart illustrating the example of FIG. 6.

Referring to FIG. 7, a user purchases a predetermined application program from an application program store by means of a first terminal 12a of the user and installs the purchased application program in 700. The first terminal 12a discovers and collects information relating to the predetermined application program and sends an update request to an application program management apparatus 10 together with the collected information in 710.

The application program management apparatus 10 updates existing information relating to the predetermined application program in response to the receipt of the update request in 720, and requests a push server 16 to send a push alarm message indicating the occurrence of an update to the second terminal 12b in 730. The push server 16 sends a push alarm message to the second terminal 12b in 740.

In response to the receipt of the push alarm message sent by the push server 16, a second terminal 12b of the user recognize the update of application program-related information, and sends a request for the transmission of information relating to the predetermined application program to the application program management apparatus 10 in 750. The application program management apparatus 10 analyzes context information of the second terminal 12b in 760. The context information includes terminal information, user information, application program information and application program execution information. The terminal information includes terminal specification information and information that may vary in real time such as terminal location information and the frequency of the use of each application program. The user information may include the user's application program use history. The application program information includes installation information and execution state information of each application program. The application program management apparatus 10 provides in 770 the updated information relating to the predetermined application program or information relating to a recommended application program associated with the predetermined application program to the second terminal 12b based on the results of the analysis performed in 760.

The second terminal 12b obtains the predetermined application program from an application program store based on the information provided by the application program management apparatus 10 and installs the obtained application program in 780.

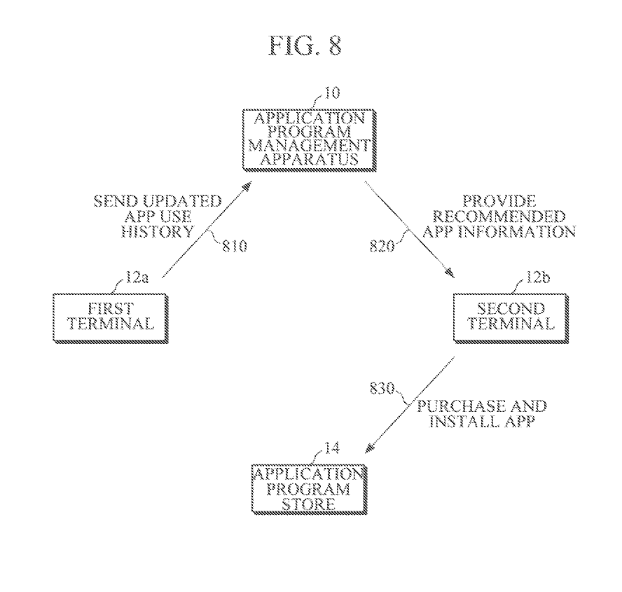

FIG. 8 is a diagram illustrating an example of the transmission of data between the application program management apparatus and terminals for providing intelligent application program-related information based on an application program use history.

Referring to FIG. 8, an application program management apparatus 10 receives a user's application program use history from each terminal of the user, for example, receives the user's application program use history, including the hitting rates of the application programs, from the second terminal 12a in 810. The application program management apparatus 10 calculates the hitting rates of application programs installed in each terminal of the user for each time period based on the user's application program use history and models and stores the user's pattern of use of application programs.

The application program management apparatus 10 creates a recommended application program list based on the user's pattern of use of the application programs, and provides the recommended application program list to the second terminal 12b in 820. In an example, the application program management apparatus 10 may use a map/reduce method to create the recommended application program list, wherein the map/reduce method involves a “map” step of sorting and grouping data in a PCC storage in the form of a list of (key, value) pairs and a “reduce” step of removing redundant data and extracting desired data from a data set obtained by the “map” step. However, the use of the map/reduce method to create the recommended application program list is merely exemplary.

The second terminal 12b displays the recommended application program list provided by the application program management apparatus 10 to the user, and the user may select a desired application program from the displayed application program list, may purchase the selected application program from an application program store 14, and may install the purchased application program in the second terminal 12b in 830.

The above-mentioned management process performed by the application program management apparatus 10 may be periodically performed independently of an application program synchronization process, and the application program management apparatus 10 may support a dynamic management process in accordance with a change in the state of the use of application programs.

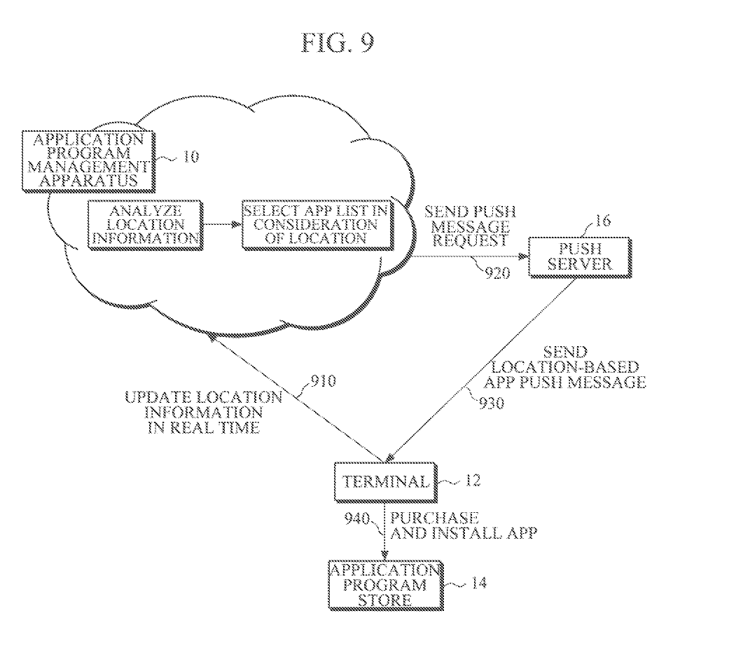

FIG. 9 is a diagram illustrating an example of the transmission of data between the application program management apparatus and terminals for providing intelligent application program-related information based on location information.

Referring to FIG. 9, an application program management apparatus 10 receives context information including location information of a terminal 12 from the terminal 12 and stores the context information in 910. In an example, the application program management apparatus 10 may store the context information in a PCC storage. The application program management apparatus 10 may create a recommended application program list based on the location of a user by analyzing the location information of the terminal 12. In an example, in response to the detection of the terminal 12 at a particular location, the application program management apparatus 10 may analyze the user's pattern of use of application programs and other users' pattern of use of application program and may create the recommended application program list based on the results of the analysis. The apparatus 10 may use the map/reduce method to create the recommended application program list.

The application program management apparatus 10 requests a push server 16 to provide a recommended application program list for the user in consideration of the user's current location in 920. The push server 16 transmits a recommended application program list to the terminal 12 in the form of a push alarm service in 930. The terminal 12 displays the recommended application program list provided by the push server 16 to the user, and the user may select a desired application program from the displayed application program list, may purchase the selected application program from an application program store 14, and may install the purchased application program in the terminal 12 in 940.

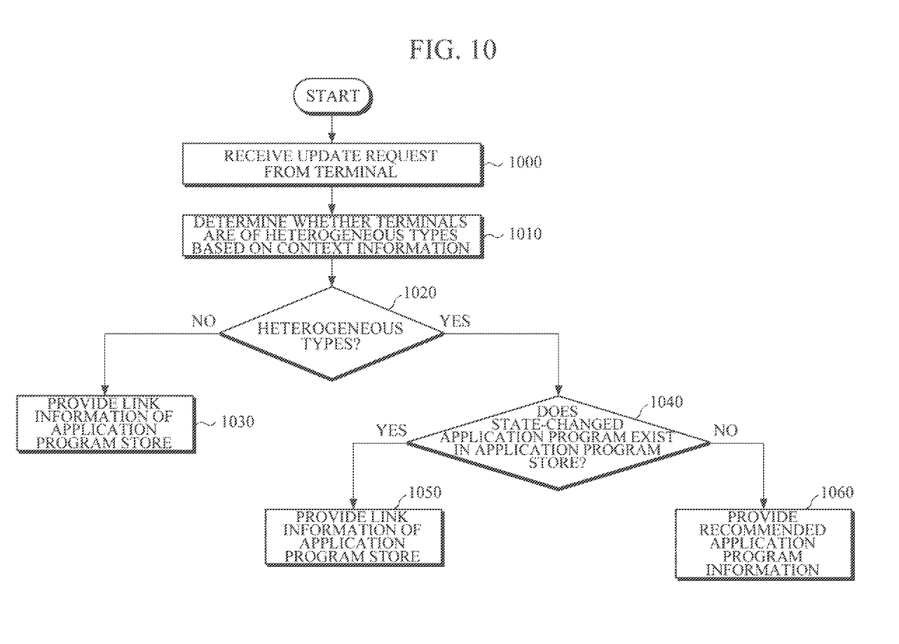

FIG. 10 is a flowchart illustrating an example of the provision of an application program based on context information.

More specifically, FIG. 10 illustrates processes that are performed in response to the receipt of an update request from a terminal that has received a push alarm message in a case in which application program-related information needs to be updated based on context information.

Referring to FIG. 10, an application program management apparatus receives in 1000 an application program update request from a terminal (hereinafter, the update-requesting terminal) that has received a push alarm message. The application program management apparatus determines in 1010 whether the update-requesting terminal and an updated terminal having an updated application program are of heterogeneous types based on context information of the update-requesting terminal. The context information includes terminal information, user information and application program information. In an example, the context information may include terminal location information, terminal property information, user preference information, application program information and application program execution information.

In response to a determination being made that the update-requesting terminal and the updated terminal are of a homogeneous type, the application program management apparatus transmits link information of an application program store from which the updated application program can be purchased or downloaded to the update-requesting terminal in 1030.

In response to a determination being made that the update-requesting terminal and the updated terminal are of heterogeneous types, the application program management apparatus determines whether the updated application program exists in an application program store of the update-requesting terminal in 1040. In response to a determination being made that the updated application program exists in the application program store of the update-requesting terminal, the application program management apparatus transmits link information of the application program store of the update-requesting terminal from which the updated application program can be purchased or downloaded to the update-requesting terminal in 1050. In response to a determination being made that the updated application program does not exist in the application program store of the update-requesting terminal, the application program management apparatus transmits information relating to one or more application programs that are recommended for being similar to the updated application program to the update-requesting terminal in 1060.

The update-requesting terminal displays the information provided by the application program management apparatus so that the user can select, purchase, and/or download one of the recommended application programs.

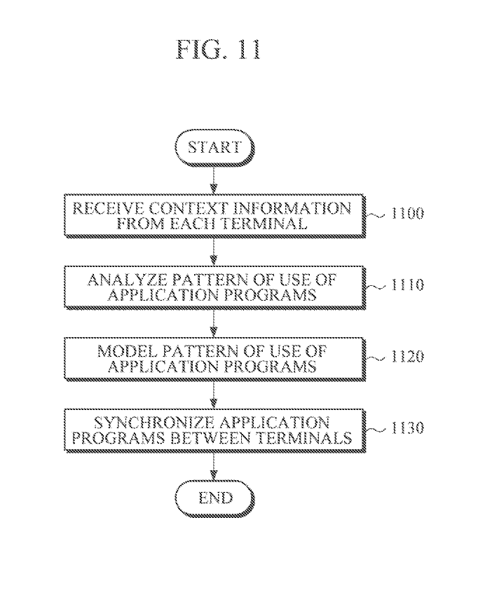

FIG. 11 is a flowchart illustrating an example of the synchronization of application programs between terminals based on context information.

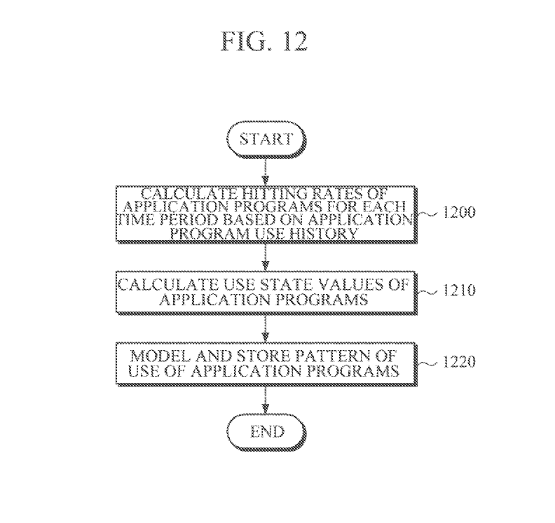

Referring to FIG. 11, an application program management apparatus receives in 1100 application program-related information and context information from each terminal of a user, and analyzes in 1110 the user's pattern of use of application programs based on the received information. The application program management apparatus models in 1120 the user's pattern of use of application programs based on the results of the analysis. The analysis and modeling of the user's pattern of use of application programs will be described later in further detail with reference to FIG. 12.

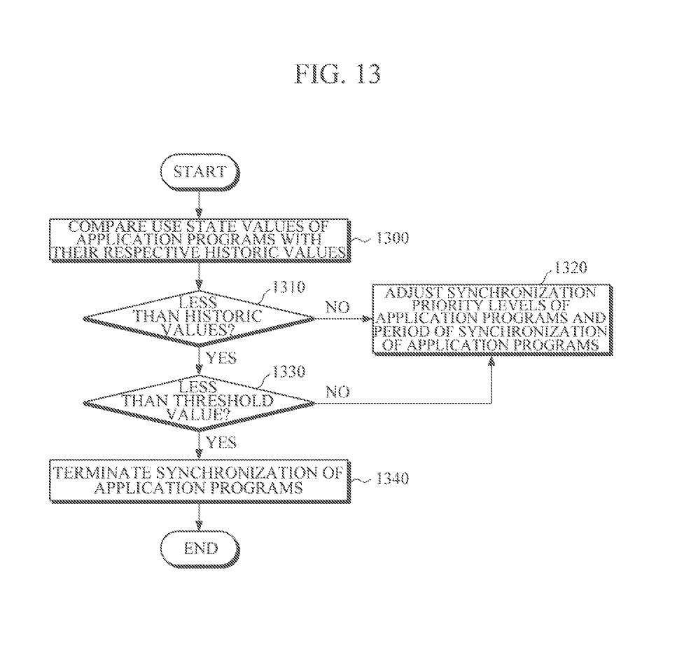

The application program management apparatus performs in 1130 application program synchronization on each terminal of the user based on the modeled pattern of use of application programs. The application program management apparatus may control and manage the period of synchronization of application programs and a list of application programs to be synchronized. A management process for the synchronization of application programs will be described later in further detail with reference to FIG. 13.

The above-mentioned management process performed by the application program management apparatus may be periodically performed independently of an application program synchronization process, and the application program management apparatus may support a dynamic management process in accordance with a change in the state of the use of application programs.

FIG. 12 is a detailed flowchart illustrating an example of the modeling of the pattern of use of application programs through analysis, as performed in the process of synchronization illustrated in FIG. 11.

Referring to FIG. 12, an application program management apparatus calculates in 1200 the hitting rates of application programs installed in each terminal of a user for each time period based on the user's application program use history, including application program information and application program hitting information collected from each terminal of the user. The application program management apparatus calculates in 1210 the use state values of the application programs based on the calculated hitting rates. The application program management apparatus models the user's pattern of use of application programs based on the calculated use state values and stores the modeled pattern of use of application programs in 1220.

FIG. 13 is a detailed flowchart illustrating an example of the control of the frequency of the synchronization of application programs and the control of application programs to be synchronized based on the state of use of each application program, as performed in the process of synchronization illustrated in FIG. 11.

Referring to FIG. 13, an application program management apparatus collects application program use state information (for example, the number of times of use of each application program during a predetermined period of time), stores the collected information, and calculates the use state value of an application program being used by the user. The application program management apparatus compares the calculated use state value with a historical value in 1300. In response to the calculated use state value being greater than the historical value, the application program management apparatus adjusts the synchronization priority level of the application program and the period of synchronization of the application program based on the calculated use state value in 1320. In an example, the application program management apparatus may increase the synchronization priority level of the application program and may shorten the period of synchronization of the application program.

In response to the calculated use state value being less than the historical value, the application program management apparatus compares the calculated use state value with a threshold value in 1330. In response to the calculated use state value being greater than the threshold value, the application program management apparatus adjusts the synchronization priority level of the application program and the period of synchronization of the application program based on the calculated use state value in 1320. On the other hand, in response to the calculated use state value being less than the threshold value, the application program management apparatus stops the synchronization of the application program in 1340. In response to the synchronization of the application program being stopped, the application program is excluded from the list of application programs to be synchronized. The application program may be added back to the list of application programs to be synchronized if the user uses the application program again.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An application program management method comprising:
in response to a state of an application program is changed, notifying a second terminal of the occurrence of an application program update in the first terminal; and
in response to the second terminal recognizing the occurrence of an application program update in the first terminal, providing the second terminal with the state-changed application program or updated information relating to the state-changed application program.

2. The application program management method of claim 1, wherein the first and second terminals are both authorized by the same user and run on a homogeneous platform or heterogeneous platforms.

3. The application program management method of claim 1, wherein the notifying comprises:
receiving an update request message for the state-changed application program and information relating to the state-changed application program from the first terminal; and
in response to the receipt of the update request message, updating existing information relating to the state-changed application program and transmitting a push alarm message indicating the occurrence of an application program update in the first terminal to the second terminal via a push server.

4. The application program management method of claim 1, wherein the providing comprises:
receiving a request for information relating to the state-changed application program from the second terminal; and
transmitting the updated information relating to the state-changed application program or information relating to a recommended application program associated with the state-changed application program to the second terminal based on context information of the second terminal.

5. The application program management method of claim 4, wherein the context information comprises terminal information, user information, application program information and application program execution information,
wherein the terminal information comprises terminal specification information and real-time information that varies in real time and includes terminal location information and the frequency of the use of each application program, the user information comprises a user's application program use history and the application program information comprises application program installation information and application program execution state information.

6. The application program management method of claim 4, wherein the updated information relating to the state-changed application program comprises link information of an application program store from which the second terminal can obtain the state-changed application program, content to be generated in response to the execution of the state-changed application program and execution state information of the state-changed application program.

7. The application program management method of claim 1, wherein the providing comprises:
in response to the receipt of a request for information relating to the state-changed application program from the second terminal, determining whether the first and second terminals are of heterogeneous types based on context information of the second terminal;
in response to a determination being made that the first and second terminals are of heterogeneous types, determining whether the state-changed application program exists in an application program store of the second terminal, transmitting link information for obtaining the state-changed application program to the second terminal in response to the state-changed application program existing in the application program store of the second terminal, and transmitting information relating to a recommended application program associated with the state-changed application program to the second terminal in response to the state-changed application program not existing in the application program store of the second terminal; and
in response to a determination being made that the first and second terminals are of a homogeneous type, transmitting link information of an application program store from which the second terminal can obtain the state-changed application program to the second terminal.

8. An application program management method comprising:
receiving application program-related information and context information from a plurality of terminals of a user and analyzing the user's pattern of use of application programs installed in each of the terminals, the plurality of terminals comprising first and second terminals;
modeling the user's pattern of use of the application programs based on the results of the analyzing; and
synchronizing the application programs between the terminals based on the modeled pattern of use of the application programs.

9. The application program management method of claim 8, wherein the synchronizing comprises recommending information relating to an application program with a predetermined frequency of use in the first terminal to the second terminal based on the modeled pattern of use of the application programs.

10. The application program management method of claim 8, wherein the synchronizing comprises controlling and managing a period of synchronization of the application programs and a list of application programs to be synchronized between the terminals.

11. The application program management method of claim 8, wherein the analyzing comprises:
calculating hitting rates of the application programs for each time period based on an application program use history included in the context information; and
calculating use state values of the application programs for each of the terminals based on the calculated hitting rates, and
the modeling comprises:
modeling the user's pattern of use of the application programs for each of the terminals based on the calculated use state values and storing the modeled pattern of use of the application programs.

12. The application program management method of claim 11, wherein the synchronizing comprises:
comparing the calculated use state values with their respective historic values;
in response to the calculated use state values being greater than their respective historic values, adjusting synchronization priority levels of the application programs and the period of synchronization of the application programs based on the calculated use state values; and
in response to the calculated use state values being less than their respective historic values, comparing the calculated use state values with a threshold value, adjusting the synchronization priority levels of the application programs and the period of synchronization of the application programs based on the calculated use state values in response to the calculated use state values being greater than the threshold value, and terminating synchronization of the application programs in response to the calculated use state values being less than the threshold value.

13. An application program management apparatus comprising:
a context modeling unit configured to collect context information from a plurality of terminals of a user and model the context information into a form suitable for use in connection with application programs;
an application program providing unit configured to provide an application program whose state is changed in a first terminal or updated information relating to the state-changed application program to a second terminal based on the modeled context information; and
an application program synchronization unit configured to in response to the detection of the state-changed application program, update existing information relating to the state-changed application program and notify the second terminal of the occurrence of an application program update in the first terminal.

14. The application program management apparatus of claim 13, wherein the context information comprises terminal information, user information, application program information and application program execution information,
wherein the terminal information comprises terminal specification information and real-time information that varies in real time and includes terminal location information and the frequency of the use of each application program, the user information comprises a user's application program use history and the application program information comprises application program installation information and application program execution state information.

15. The application program management apparatus of claim 13, wherein the updated information relating to the state-changed application program comprises link information of an application program store from which the second terminal can obtain the state-changed application program, content to be generated in response to the execution of the state-changed application program and execution state information of the state-changed application program.

16. The application program management apparatus of claim 13, wherein the context modeling unit is further configured to calculating hitting rates of application programs installed in each of the terminals for each time period based on an application program use history included in the context information, calculate use state values of the application programs for each of the terminals based on the calculated hitting rates, model the user's pattern of use of the application programs for each of the terminals based on the calculated use state values and store the modeled pattern of use of the application programs.

17. The apparatus of claim 13, wherein the application program synchronization unit is further configured to in response to the receipt of an update request message for the state-changed application program and information relating to the state-changed application program from the first terminal, update the existing information relating to the state-changed application program and transmit a push alarm message to the second terminal via a push server.

18. The apparatus of claim 13, wherein the application program providing unit is further configured to in response to the receipt of a request for the state-changed application program from the second terminal, transmit the updated information relating to the state-changed application program or information relating to a recommended application program associated with the state-changed application program to the second terminal based on context information of the second terminal.

19. The apparatus of claim 13, wherein the application program providing unit is further configured to:
in response to the receipt of a request for information relating to the state-changed application program from the second terminal, determine whether the first and second terminals are of heterogeneous types based on context information of the second terminal;
in response to a determination being made that the first and second terminals are of heterogeneous types, determine whether the state-changed application program exists in an application program store of the second terminal, transmit link information for obtaining the state-changed application program to the second terminal in response to the state-changed application program existing in the application program store of the second terminal, and transmit information relating to a recommended application program associated with the state-changed application program to the second terminal in response to the state-changed application program not existing in the application program store of the second terminal; and
in response to a determination being made that the first and second terminals are of a homogeneous type, transmit link information of an application program store from which the second terminal can obtain the state-changed application program to the second terminal.
